(19) United States
(12) Patent Application Publication
(10) Pub. No.: US 2008/0178949 A1
(43) Pub. Date: Jul. 31, 2008

(54) Actuating valve with dual balls connected by pin

(76) Inventors: Alejandro Moreno, El Paso, TX (US); Leon M. Vargas, Vancouver (CA)

Correspondence Address: DELPHI TECHNOLOGIES, INC., M/C 480-410-202, PO BOX 5052, TROY, MI, 48007, US

(21) Appl. No.: 11/700,673

(22) Filed: Jan. 31, 2007

(51) Int. Cl. F17D 1/08

(52) U.S. Cl. 137/596

(57) ABSTRACT

A solenoid-operated valve has an exhaust seat (42) through which fluid can flow to an exhaust port (32) of the valve. Fluid can also flow through a control/supply seat (46) from a supply port (30) of the valve to a control port (28) of the valve. An axially rigid assembly includes first and second ball (40, 48) distanced from each other but connected such that pressure against one ball that is sufficient to cause it to move always moves the other ball. The exhaust seat (42) is blocked by the first ball (40) when the control/supply seat (46) is not blocked, and the control/supply seat (46) is blocked by the second ball (48) when the exhaust seat (42) is not blocked.

### FIELD OF THE INVENTION

The present invention relates generally to valves for vehicle hydraulic systems such as automatic transmission systems.

### BACKGROUND OF THE INVENTION

Modern vehicles have many control systems in which a controller, in response to sensor signals, actuates vehicle components to control the vehicle. As one illustration, an engine control module (ECM) might receive input from various sensors and in response turn “on” and “off” actuation coils of various hydraulic valves to cause an automatic transmission to shift.

Solenoid valves may include a ball that is urged against a first seat or a second seat depending on whether the solenoid is energized to selectively establish various paths of fluid flow through the valve. It is desired that low leakage exists past the ball when it is seated. As understood herein, to provide optimal low leakage operation, past valves introduce drawbacks depending on their design, including undesirable flow restrictions. The present invention is provided with these critical recognitions in mind.

### SUMMARY OF THE INVENTION

A valve has a valve body, an exhaust port, a supply port, and a control port. The valve also has a plunger that is movable by an actuating solenoid. A first ball is disposed in an end of the plunger and is juxtaposed with an exhaust seat, while a second ball is in the valve body and is juxtaposed with a control/supply seat. An axially rigid pin extends from the first ball to the second ball and is in perpetual contact with both balls. The valve assumes a first configuration when the solenoid is in a first state, wherein the first ball is distanced from the exhaust seat and the second ball blocks the control/supply seat such that a pathway for fluid communication is established from the control port to the exhaust port. In contrast, the valve assumes a second configuration when the solenoid is in a second state, wherein the first ball blocks the exhaust seat and the second ball is distanced from the control/supply seat such that a pathway for fluid communication is established from the supply port to the control port.

The first state of the solenoid may be a deenergized state and the second state may be an energized state. In non-limiting implementations a plate is interposed between the solenoid and valve body and the plate establishes the exhaust seat. The plate can also, in an alternative embodiment, establish a mounting bracket for the valve.

In specific non-limiting embodiments the valve body defines the supply and control ports, and more specifically the supply port may be defined by an open end of the valve body. A seat member can be disposed in the valve body to establish the control/supply seat, with the pin extending through the plate and the seat member. The exhaust port can be formed between the solenoid housing and the plate.

In another aspect, a valve has an exhaust seat through which fluid can flow to an exhaust port of the valve, and a control/supply seat through which fluid can flow from a supply port of the valve to a control port of the valve. An axially rigid assembly includes first and second balls distanced from each other but connected such that pressure against one ball that is sufficient to cause it to move always moves the other ball. The exhaust seat is blocked by the first ball when the control/supply seat is not blocked, and the control/supply seat is blocked by the second ball when the exhaust seat is not blocked.

In yet another aspect, a valve has a valve body defining a control port and a supply port. The valve also has a seat member disposed within the valve body and defining a control/supply seat, a solenoid housing, and a primary plate disposed between the valve body and solenoid housing and defining an exhaust seat. A plunger is reciprocatingly movable within the solenoid housing, and a solenoid is energizable to move the plunger to cause the exhaust seat to be blocked and the control/supply seat to be unblocked to permit fluid communication from the supply port to the control port. The solenoid can be deenergized to cause fluid pressure at the supply port to move the plunger and cause the exhaust seat to be unblocked and the control/supply seat to be blocked to permit fluid communication from the control port to an exhaust port.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present valve in one non-limiting environment;

FIGS. 2 and 3 are isometric views of the valve, showing the supply, control, and exhaust ports;

FIG. 4 is a cross-section of the valve as seen along the line 4-4 in FIG. 2, with the valve in the deenergized configuration; and

FIG. 5 is an exploded perspective view of the valve.

### DETAILED DESCRIPTION OF THE PREFERRED EMBODIMENT

The present invention is intended for application in automotive vehicle transmission systems and will be described in that context. It is to be understood, however, that the present invention could also be successfully applied in many other applications. Other applications include but are not limited to vehicle heavy equipment applications, engine cam phasing, etc. It is to be further understood that while relative terms of orientation are used herein such as “upper”, “lower”, “bottom”, etc., these terms are for the reader's convenience only and are in relation to the drawing orientations on the page, and thus do not constrain the valve to be mounted in any particular orientation in use.

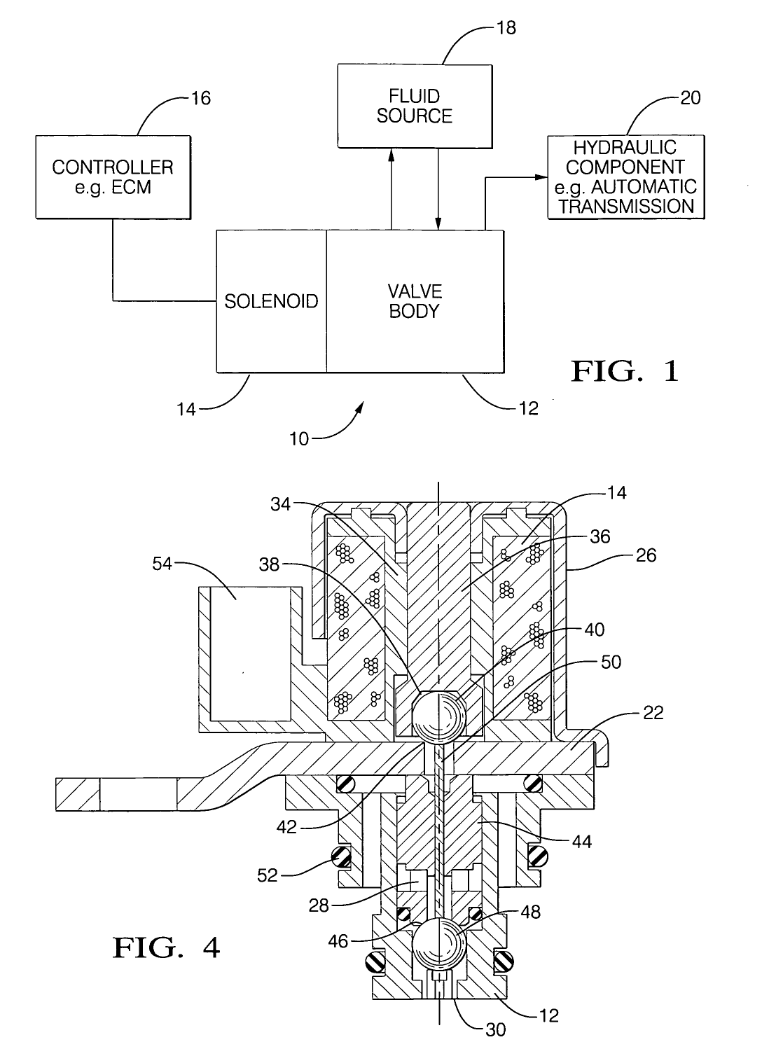

Referring initially to FIG. 1, a valve 10 is shown that includes a rigid valve body 12 and an actuating solenoid 14. The solenoid 14 can be energized and deenergized under the control of a controller 16 such as an engine control module (ECM) to move below-described components within the valve body 12 to selectively port hydraulic fluid from a fluid source 18 (such as a hydraulic pump or pressurized reservoir) to and from a hydraulic component 20, such as a vehicle automatic transmission.

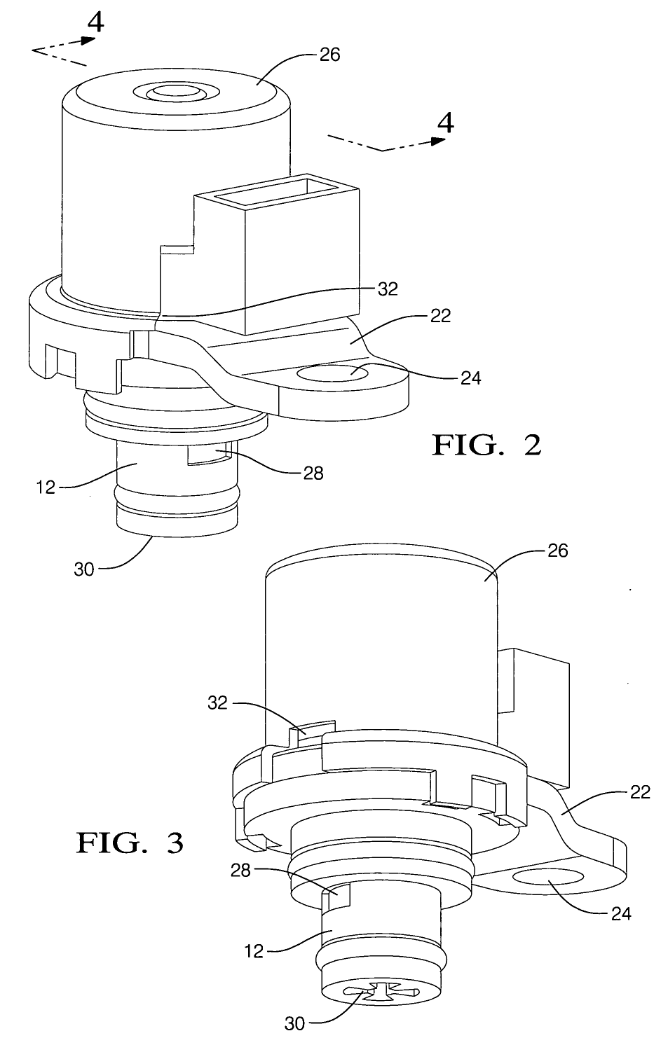

FIGS. 2 and 3 show that the valve body 12 is engaged with a rigid primary plate 22 having a bracket portion extending from the valve body 12 with a hole 24 for mounting the valve on another component. The solenoid 14 shown in FIG. 1 is disposed within a hollow cylindrical metal solenoid housing 26 that is crimped or otherwise attached to the primary plate 22. As shown in FIGS. 2 and 3, the side of the preferably cylindrical valve body 12 is formed with a control port 28 that can be connected to the hydraulic component 20 shown in FIG. 1 for operating the component 20. Also, the bottom of the valve body 12 is open to establish a supply port 30 that can be connected to the fluid source 18 shown in FIG. 1 for receiving fluid from the source. An exhaust port 32 is formed near the bottom of the solenoid housing 26 just above the primary plate 22 as shown, and the exhaust port 32 can also be connected to the fluid source 18 for returning fluid to the source.

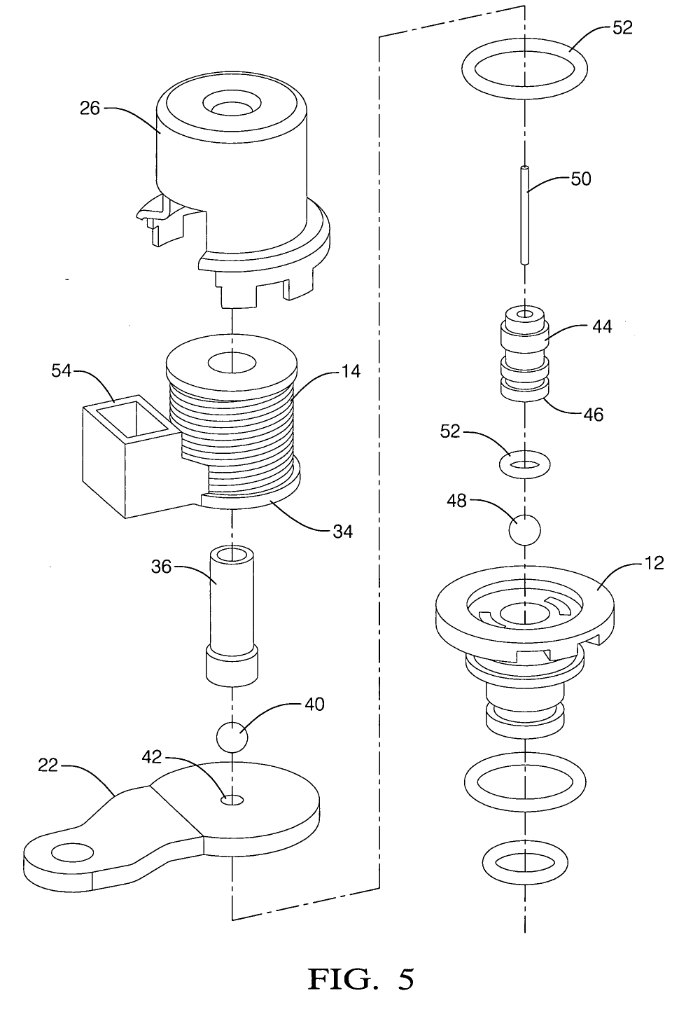

Now referring to FIGS. 4 and 5 for details of the valve 10, the solenoid 14, which can be established by a wire coil, is wound around a spool 34 and disposed within the coil housing 26. A plunger 36 is reciprocatingly disposed within the spool 34. The plunger 36 has a lower end formed with a cavity 38 in which an upper ball 40 is partially disposed, with a portion of the ball 40 protruding beyond the end of the plunger 36 as best shown in FIG. 4. With the ball, typically made of ferromagnetic material, thus being closely associated with the plunger, the plunger-to-ball magnetic coupling advantageously is strong.

A conical exhaust seat 42 is formed in the primary plate 22, and as discussed further below the plunger can move up in FIG. 4 when the solenoid 14 is deenergized with structure below distancing the upper ball 40 from the exhaust seat 42, permitting fluid to flow from the control port 30 to the exhaust port 32. On the other hand, when the solenoid 14 is energized, the plunger moves down in FIG. 4 to seat the upper ball within the exhaust seat 42 and thus prevent fluid from flowing from the supply and control ports 30, 28 to the exhaust port 32.

A hollow, rigid, somewhat elongated seat member 44 is immovably disposed in the valve body 12 below the primary plate 22 as shown. The open lower end of the seat member 44 forms a conical control/supply seat 46, and a lower ball 48 is positioned below the control/supply seat 46 to selectively block it. An elongated axially rigid pin 50 extends through the primary plate 22 and seat member 44 as shown and remains on contact with both balls 40, 48 throughout the operation of the valve 10.

Various o-rings 52 can be used within and around the valve body 12 as shown in accordance with principles known in the art to provide appropriate seals. Also, an electrical connector receptacle 54 can be engaged with the solenoid housing 22 so that a connector can be advanced into the receptacle and electrically connected to the solenoid to energize the solenoid.

With the above structure in mind, the operation of the valve 10 can now be appreciated. When the solenoid is deenergized, fluid pressure from the supply port 30 pushes up against the lower ball 48 such that the axial combination of structure consisting of the lower ball 48, pin 50, upper ball 40, and plunger 36 are all moved up, looking down on FIG. 4. In the deenergized configuration (shown in FIG. 4), the lower ball 48 is pushed against the control/supply seat 46, and the upper ball 40 is distanced from the exhaust seat 42, so that a path for fluid communication is opened between the control port 28 and exhaust port 32. In contrast, when the solenoid 14 is energized, the plunger 36 moves down looking down at FIG. 4, seating the upper ball 40 against the exhaust seat 42 and unseating the lower ball 48 to thereby permit fluid communication between the supply port 30 and control port 28.

Whiles the particular ACTUATING VALVE WITH DUAL BALLS CONNECTED BY PIN is herein shown and described in detail, it is to be understood that the subject matter which is encompassed by the present invention is limited only by the claims.

What is claimed is:

1. A valve, comprising:
a valve body;
an exhaust port, a supply port, and a control port;
a plunger movable by an actuating solenoid;
a first ball disposed in an end of the plunger and juxtaposed with an exhaust seat;
a second ball in the valve body and juxtaposed with a control/supply seat; and
an axially rigid pin extending from the first ball to the second ball and in perpetual contact therewith, wherein the valve assumes a first configuration when the solenoid is in a first state, wherein the first ball is distanced from the exhaust seat and the second ball blocks the control/supply seat such that a pathway for fluid communication is established from the control port to the exhaust port, the valve assuming a second configuration when the solenoid is in a second state, wherein the first ball blocks the exhaust seat and the second ball is distanced from the control/supply seat such that a pathway for fluid communication is established from the supply port to the control port.

2. The valve of claim 1, wherein the first state of the solenoid is a deenergized state and the second state is an energized state.

3. The valve of claim 1, comprising a plate interposed between the solenoid and valve body and establishing the exhaust seat, the plate also establishing a mounting bracket for the valve.

4. The valve of claim 1, wherein the valve body defines the supply and control ports.

5. The valve of claim 4, wherein the supply port is defined by an open end of the valve body.

6. The valve of claim 3, comprising a seat member disposed in the valve body and establishing the control/supply seat, the pin extending through the plate and the seat member.

7. The valve of claim 1, comprising a solenoid housing holding the solenoid, wherein the exhaust port is formed between the solenoid housing and the plate.

8. A valve, comprising:
an exhaust seat through which fluid can flow to an exhaust port of the valve;
a control/supply seat through which fluid can flow from a supply port of the valve to a control port of the valve; and
an axially rigid assembly including first and second balls distanced from each other but connected such that pressure against one ball sufficient to cause it to move always moves the other ball, the exhaust seat being blocked by the first ball when the control/supply seat is not blocked, the control/supply seat being blocked by the second ball when the exhaust seat is not blocked.

9. The valve of claim 8, further comprising:
an actuating solenoid;
a plunger movable by the actuating solenoid, the first ball being in contact with the plunger;
a valve body holding the second ball; and
an axially rigid pin extending from the first ball to the second ball and in perpetual contact therewith.

10. The valve of claim 9, wherein the exhaust seat is blocked by the first ball and the control/supply seat is not blocked when the solenoid is deenergized, the control/supply seat being blocked by the second ball and the exhaust seat not being blocked when the solenoid is energized.

11. The valve of claim 9, comprising a plate interposed between the solenoid and valve body and establishing the exhaust seat.

12. The valve of claim 9, wherein the valve body defines the supply and control ports.

13. The valve of claim 12, wherein the supply port is defined by an open end of the valve body.

14. The valve of claim 9, comprising a seat member disposed in the valve body and establishing the control/supply seat, the pin extending through the plate and the seat member.

15. A valve, comprising:
a valve body defining a control port and a supply port;
a seat member disposed within the valve body and defining a control/supply seat;
a solenoid housing;
a primary plate disposed between the valve body and solenoid housing and defining an exhaust seat;
a plunger reciprocatingly movable within the solenoid housing; and
a solenoid energizable to move the plunger to cause the exhaust seat to be blocked and the control/supply seat to be unblocked to permit fluid communication from the supply port to the control port, the solenoid being deenergizable to cause fluid pressure at the supply port to move the plunger and cause the exhaust seat to be unblocked and the control/supply seat to be blocked to permit fluid communication from the control port to an exhaust port.

16. The valve of claim 15, comprising a first ball in perpetual contact with the plunger and juxtaposed with the exhaust port, an elongated pin in perpetual contact with the first ball, and a second ball in perpetual contact with the pin, the second ball being disposed in the valve body adjacent the control/supply seat.

17. The valve of claim 16, wherein the exhaust seat is blocked by the first ball and the control/supply seat is not blocked when the solenoid is deenergized, the control/supply seat being blocked by the second ball and the exhaust seat not being blocked when the solenoid is energized.

18. The valve of claim 15, wherein the supply port is defined by an open end of the valve body.
